(19) United States
(12) Patent Application Publication
(10) Pub. No.: US 2019/0164108 A1
(43) Pub. Date: May 30, 2019

(54) MERGING DATA SECURELY FROM DIFFERENT SOURCES

(71) Applicant: Microsoft Technology Licensing, LLC, Redmond, WA (US)

(72) Inventors: Andrew Walter Chimka, San Francisco, CA (US); Monica Marie Lewis, Menlo Park, CA (US); Xie Lu, Sunnyvale, CA (US); Emily Louise Mitchell, San Francisco, CA (US); Yeqin Zhang, Sunnyvale, CA (US); Yixiao Lu, San Jose, CA (US)

(21) Appl. No.: 15/828,093

(22) Filed: Nov. 30, 2017

(51) Int. Cl. G06Q 10/06; G06Q 50/00; G06F 17/30

(52) U.S. Cl. CPC G06Q 10/063112; G06Q 50/01; G06F 17/30861; G06F 17/30011; G06F 17/30997

(57) ABSTRACT

Techniques for merging data securely from different sources are disclosed herein. In some embodiments, a computer-implemented method comprises: receiving criteria for a job posting; receiving a plurality of job applications, each corresponding to a different applicant and comprising resume data and application contact information; for each job application, determining that the application contact information matches profile contact information of the corresponding applicant; for each job application, merging the resume data of the job application with profile data of the applicant to form application data based on the determining that the application contact information matches the profile contact information, the application data comprising the resume data and the profile data; for each applicant, generating a corresponding match strength based on a comparison of the application data with the at least one criteria; and causing at least a portion of the applicants to be displayed based on the generated match strength.

### TECHNICAL FIELD

The present application relates generally to data security and verification and, in one specific example, to methods and systems of merging data securely from different sources.

### BACKGROUND

When accessing, retrieving, and performing operations with data from different data sources, a problem arises in the accuracy and appropriateness of such operations for the data. For example, although it may be intended for a computer system to perform an operation on a first set of data associated with a user and a second set of data associated with the user in order to generate a result for the user, the first set of data or the second set of data might not actually be associated with the user. As a result, the data of some other user may be inappropriately accessed, retrieved, and processed. This issue represents a security problem and an accuracy problem for the computer system.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a merge and match system, in accordance with an example embodiment.

FIG. 4 illustrates a graphical user interface (GUI) in which users can view a job posting published on an online service, in accordance with an example embodiment.

FIG. 5 illustrates a GUI in which a user can submit an application for a job posting, in accordance with an example embodiment.

FIG. 6 illustrates a GUI in which applicants for the job posting are displayed, in accordance with an example embodiment.

FIG. 7 illustrates a GUI in which application data of an applicant that satisfies criteria of a job posting is displayed, in accordance with an example embodiment.

FIG. 8 is a flowchart illustrating a method of merging data securely from different sources, in accordance with an example embodiment.

FIG. 9 is a flowchart illustrating a method of causing applicants to be displayed, in accordance with an example embodiment.

FIG. 10 is a block diagram illustrating a mobile device, in accordance with some example embodiments.

FIG. 11 is a block diagram of an example computer system on which methodologies described herein may be executed, in accordance with an example embodiment.

### DETAILED DESCRIPTION

Example methods and systems of merging data securely from different sources are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to enable a computer system to verify that the correct data is being accessed, retrieved, and processed. As a result, the computer system is able to securely merge data from different data sources. Additionally, other technical effects will be apparent from this disclosure as well.

In some example embodiments, operations are performed by a computer system (or other machine) having a memory and at least one hardware processor, with the operations comprising: receiving at least one criteria for a job posting published on an online service; receiving a plurality of job applications for the job posting, each one of the job applications corresponding to a different applicant and comprising resume data and application contact information; for each one of the plurality of job applications, determining that the application contact information of the job application matches profile contact information stored in association with a profile of the corresponding applicant of the job application on a social networking service; for each one of the plurality of job applications, merging the resume data of the job application with profile data of the profile of the corresponding applicant of the job application to form application data of the job application, the application data comprising the resume data and the profile data, the merging of the resume data with the profile data comprises retrieving the profile data from a database of the social networking service and being performed based on the determining that the application contact information matches the profile contact information, for each one of the applicants of the plurality of job applications, generating a corresponding match strength based on a comparison of the application data of the job application of the applicant with the at least one criteria; and causing at least a portion of the applicants of the plurality of job applications to be displayed on a computing device based on the generated match strengths of the job applications.

In some example embodiments, the corresponding match strength of each one of the job applicants is based on a measure of similarity between the application data of the job application of the applicant and the at least one criteria.

In some example embodiments, the contact information comprises at least one of an e-mail address or a destination for receiving text messages. In some example embodiments each one of the job applications further comprises an identification of the corresponding applicant, and the profile data of the profile of each one of the applicants is retrieved using the identification of the corresponding applicant.

In some example embodiments, the merging of the resume data with the profile data is performed in response to the determining that the application contact information matches the profile contact information. In some example embodiments, the retrieving the profile data is performed in response to the determining that the application contact information matches the profile contact information.

In some example embodiments, the causing the at least a portion of the applicants to be displayed on the computing device comprises: ordering the applicants of the plurality of job applications based on the generated match strengths of the applicants; and causing the at least a portion of the applicants to be displayed on the computing device based on the ordering of the applicants.

In some example embodiments, the operations further comprise: receiving a user input indicating a selection of an applicant of the at least a portion of the applicants; and in response to receiving the user input, causing at least a portion of the application data of the job application of the applicant to be displayed on the computing device, the at least a portion of the application data being determined based on the at least a portion of the application data satisfying the at least one criteria. In some example embodiments, the at least a portion of the application data comprising at least a portion of the resume data and at least a portion of the profile data. In some example embodiments, the user input comprises a hover event of a pointer over the applicant displayed on the computing device.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

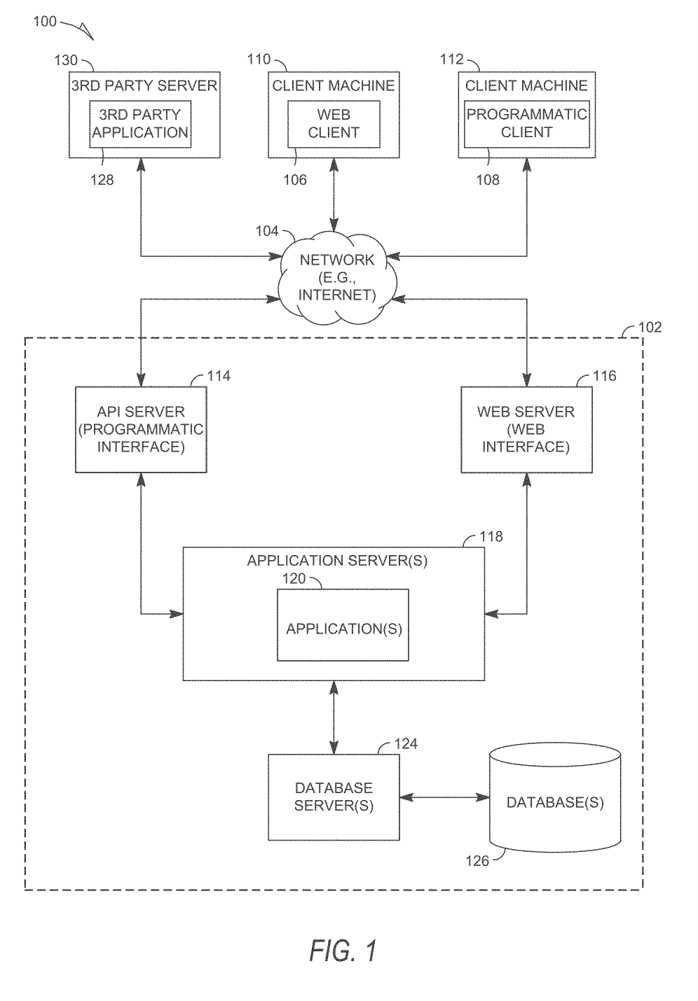

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

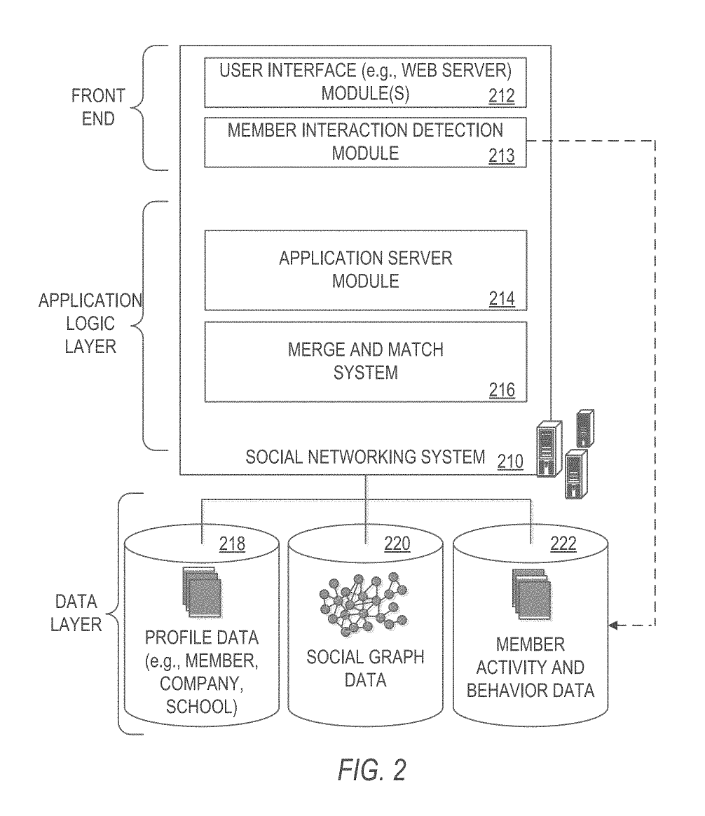

In some embodiments, the networked system 102 may comprise functional components of a social networking service. FIG. 2 is a block diagram showing the functional components of a social networking system 210, including a data processing module referred to herein as a merge and match system 216, for use in social networking system 210, consistent with some embodiments of the present disclosure. In some embodiments, the merge and match system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the merge and match system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the merge and match system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

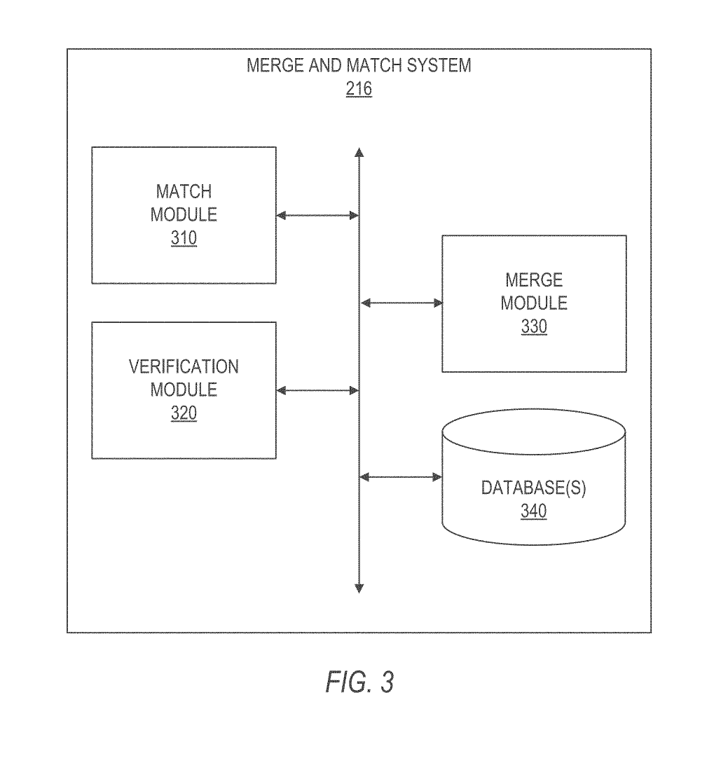

FIG. 3 is a block diagram illustrating components of the merge and match system 216, in accordance with an example embodiment. In some embodiments, the merge and match system 216 comprises any combination of one or more of a match module 310, a verification module 320, a merge module 330, and one or more database(s) 340. The modules 310, 320, and 330 and the database(s) 340 can reside on a computer system, or other machine, having a memory and at least one processor (not shown). In some embodiments, the modules 310, 320, and 330 and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, as well as the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310 and 320 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access social graph data and member activity and behavior data from database(s) 340, as well as exchange information with third party servers 130, client machines 110, 112, and other sources of information.

In some example embodiments, the merge and match system 216 is configured to merge profile data of a user (e.g., a member) of an online serve (e.g., a social networking service) with resume data submitted by the user when the user submits a job application for a job posting published on the online service in order to create the most complete view of the user's identity. The merge and match system 216 may then order or re-order all of the users who have submitted job applications for the job posting based on how strongly each of their corresponding merged information matches the criteria of the job posting.

In some example embodiments, the match module 310 is configured to receive at least one criteria for a job posting published on an online service. The online service may comprise a social networking service, such as the social networking system 210 in FIG. 2. However, it is contemplated that other types of online services are also within the scope of the present disclosure. In some example embodiments, a user that is responsible for posting or managing the job posting specifies the criteria for the job posting. Such criteria comprises any characteristics, features, or aspects that the user is seeking in applicants for the job posting, including, but not limited to, skills, degrees, years of experience, industries, functions, seniority level, industries in which the applicant has worked, the type of employment being sought, and location. The online service may publish the criteria of the job posting in association with the job posting.

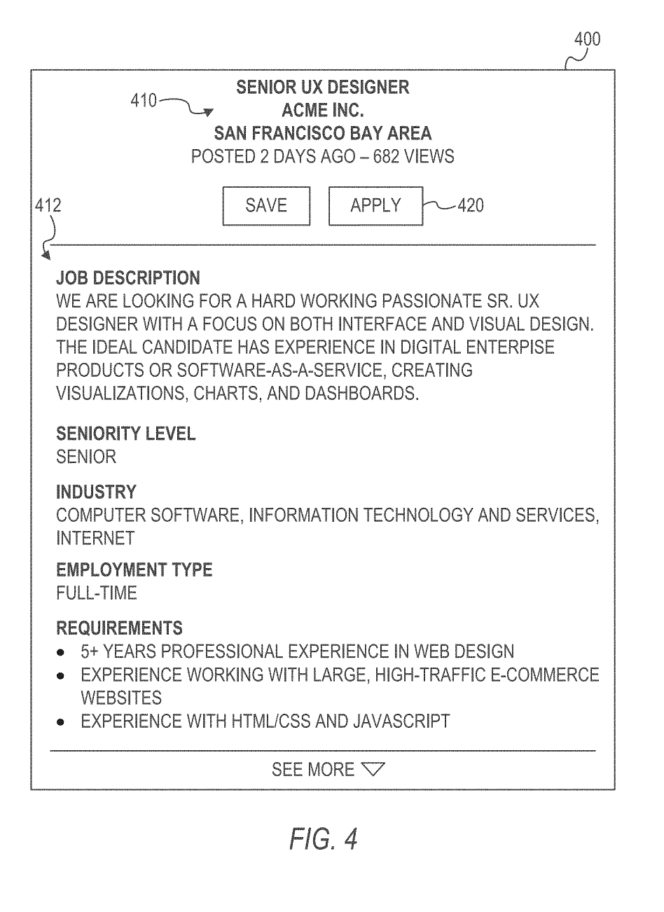

FIG. 4 illustrates a GUI 400 in which users can view a job posting published on an online service, in accordance with an example embodiment. In FIG. 4, the job posting comprises headline information 410 and detailed information 412. The headline information 410 comprises basic information about the job posting, such as the job title or position (e.g., “SENIOR UX DESIGNER”), the name of the company or organization seeking applicants for the job title or position (e.g., “ACME INC.”), and the location of the job (e.g., “SAN FRANCISCO BAY AREA”). The detailed information 412 comprises more detailed information about the job, including, but not limited to, a job description, a seniority level of the job, one or more industries to which the job corresponds, an employment type for the job, and requirements for the job. The match module 310 may retrieve the criteria for the job posting from a database in which the criteria is stored as structured data, or may parse the published job posting to extract the relevant criteria.

In FIG. 4, the GUI 400 also comprises a selectable user interface element 420 configured to enable a user who is viewing the job posting to submit a job application for the job posting. In some example embodiments, the selectable user interface element 420 comprises a selectable button or link (e.g., the selectable “APPLY” button in FIG. 4) that is configured to, when selected, trigger the merge module 310 to display another GUI in which the user can submit an application for the job posting.

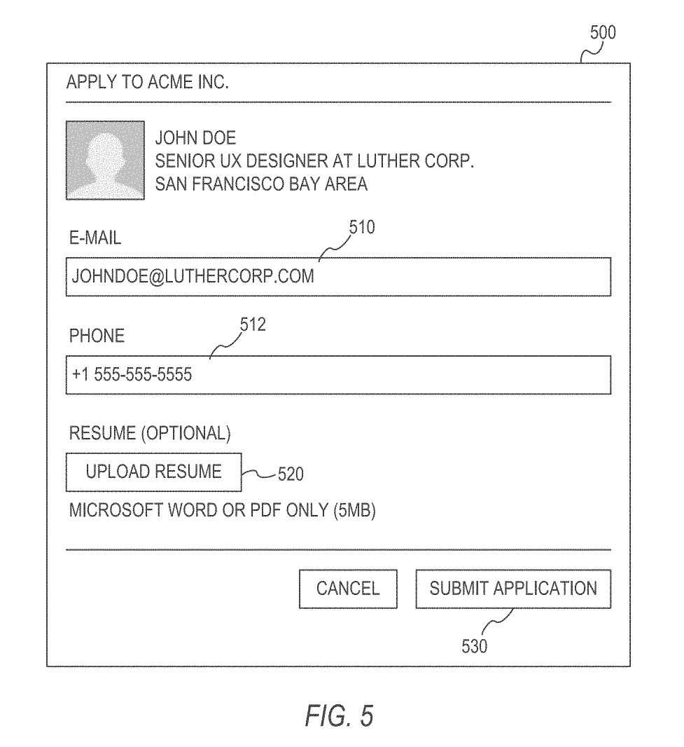

FIG. 5 illustrates a GUI 500 in which a user can submit an application for the job posting, in accordance with an example embodiment. In some example embodiments, the GUI 500 comprises one or more user interface elements configured to enable the user to submit contact information, such as an e-mail address and/or a destination for receiving text messages (e.g., a phone number). For example, the GUI 500 comprises a text field 510 configured to receive an e-mail address of the user, as well as a text field 512 configured to receive a destination for receiving text messages.

In some example embodiments, the GUI 500 also comprises one or more user interface elements configured to enable the user to submit resume data. For example, the GUI 500 comprises a selectable user interface element 520 configured to enable the user to upload a resume in a certain format, such as a Microsoft Word document or a Portable Document Format (PDF). In response to the user selecting the selectable user interface element 520, the merge module 310 may display a window (not shown) in which a user may select a file containing a resume to upload. Alter the user has entered contact information and uploaded a resume, the user may submit the entered contact information and the uploaded resume file to the merge and match system 216 for processing using a selectable user interface element 530 (e.g., a “SUBMIT APPLICATION” button). The entered contact information and the uploaded resume file may form a job application of the user, who is now recognized by the merge and match system 216 as an applicant for the job posting based on the submission of the entered contact information and the uploaded resume. In some example embodiments, the match module 310 is configured to parse the content of the uploaded resume file into structured data. The match module 310 may use natural language processing to determine what content within the uploaded resume file qualifies as resume data, and then store that content as structured resume data of the job application in the database(s) 340.

In some example embodiments, the match module 310 parses out terms from the resume file, and then performs a standardization procedure on the terms, translating them into terminology that is more suitable for processing in evaluating the resume data with respect to the criteria of the job posting. The match module 310 may use a dictionary of attributes, such as skills, industries, and education, to translate the terms into different terms. For example, the match module 310 may parse out the term “Java” from a resume file, determine that the term “Java” matches a specific attribute recognized by the merge and match system 216 (e.g., skill 237). By converting the terms from the resume file to standardized terms, the match module 310 ensures that it can properly evaluate the resume data with respect to the criteria of the job posting.

In some example embodiments, the match module 310 is configured to receive a plurality of job applications for a single job posting, with each one of the job applications corresponding to a different applicant and comprising resume data and application contact information. Despite the inclusion of resume data, each job application may still lack relevant information, as information is often omitted from resumes in an attempt to avoid exceeding maximum page length requirements for a resume and overwhelming the reader of the resume. Additionally, people often neglect to update their resumes with the most current information.

In some example embodiments, the merge and match system 216 provides a remedy for this lack of relevant information by retrieving profile data of the applicant from another source, and merging the retrieved profile data with the resume data. The profile data of the applicant is stored in association with a profile of the applicant (e.g., a digital representation of the applicant's identity) on a social networking service. For example, the profile data of the applicant may comprise the profile data stored in database 218 of FIG. 2.

In some example embodiments, the merge module 330 is configured to, for each one of a plurality of job applications for a job posting, merge the resume data of the job application with profile data of the profile of the corresponding applicant of the job application to form application data of the job application. As a result of the merge, the application data comprises the resume data and the profile data. In some example embodiments, each one of the job applications comprises an identification of the corresponding applicant (e.g., a name of the applicant), and the profile data of the profile of each one of the applicants is retrieved using the identification of the corresponding applicant, such as by a look-up of the identification in the database of the social networking service to find the profile of the applicant having the same identification. It is contemplated that the profile data may be found, accessed, and retrieved in other ways as well.

In retrieving the profile data, there is a risk that the merge module 330 will retrieve the profile data of the wrong user. For example, the social networking service may store multiple profiles of users having the same name (e.g., two users having the name “John Doe”). As a result, the merge process may be susceptible to error. In some example embodiments, in order to avoid retrieving profile data of the wrong user, contact information is used to verify that the profile data of the correct user is being accessed, retrieved, and processed.

In some example embodiments, the verification module 320 determines whether or not the application contact information of the job application (e.g., the contact information entered via GUI 500 in FIG. 5) matches profile contact information stored in association with a profile of the applicant on the social networking service. For example, the verification module 320 may compare an e-mail address entered by an applicant as part of the job application with an e-mail address stored in association with a profile of the applicant on the social networking service, or compare a phone number entered by an applicant as part of the job application with an e-mail address stored in association with a profile of the applicant on the social networking service. Based on the determination by the verification module 320 of whether the application contact information of the job application matches profile contact information stored in association with a profile of the applicant on the social networking service, the merge and match system 216 may determine whether to merge the resume data with the profile data.

In some example embodiments, the merge module 330 is configured to perform the merging of the resume data with the profile data in response to, or otherwise based on, a determination by the verification module 320 that the application contact information matches the profile contact information. In some example embodiments, the merge module 330 is configured to use the determination by the verification module 320 to determine whether to retrieve the profile data, basing the retrieving of the profile data on a determination by the verification module 320 that the application contact information matches the profile contact information. For example, the merge module 330 may perform the retrieval of the profile data in response to, or otherwise based on, a determination that the application contact information matches the profile contact information.

In some example embodiments, the merge module 330 is configured to perform data deduplication to on the application data to remove duplicate copies of repeating data in situations where the same attribute is included in both the resume data and the profile data. This data deduplication process helps conserve electronic resources, such as memory space.

In some example embodiments, the match module 310 is configured to, for each one of the applicants of the plurality of job applications, generate a corresponding match strength based on a comparison of the application data of the job application of the applicant with the criteria for the job posting, where the application data comprises both the resume data and the retrieved profile data. In some example embodiments, the corresponding match strength of each one of the job applicants is based on a measure of similarity between the application data of the job application of the applicant and the criteria for the job posting. For example, if there are thirty different criteria for a particular job posting, the match module 310 may determine how many of the thirty different criteria are satisfied by the application data of a job applicant, and then generate a match strength for that job applicant based on that determination of how many of the thirty different criteria are satisfied, with the higher the number of criteria being satisfied resulting in a higher match strength. In some example embodiments, the match strength may comprise a number or a letter representing the measure of similarity between the application data of the job application of the applicant and the criteria for the job posting. However, it is contemplated that other forms of a match strength may also be employed within the scope of the present disclosure.

In some example embodiments, the match module 310 is configured to weight the resume data and the profile data differently in generating the match strength. In some example embodiments, the match module 310 determines which of the resume data and the profile data has been updated most recently (e.g., by analyzing the metadata of the resume file and accessing profile records on the social networking service) and weights that data more heavily in the generation of the match strength in situations where it is a match with the criteria of the job posting.

In some example embodiments, the match module 310 is configured to cause at least a portion of the applicants of the plurality of job applications to be displayed on a computing device based on the generated match strengths of the job applications. For example, the match module 310 may determine the N highest match strengths of the job applications, with N being any positive integer (e.g., the five highest match strengths), and then cause indications of the applicants of the job applications corresponding to the N highest match strengths to be displayed on the computing device. In some example embodiments, the match module 310 is configured to order the applicants of the plurality of job applications based on the generated match strengths of the applicants, and to cause at least a portion of the applicants to be displayed on the computing device based on the ordering of the applicants. For example, the match module 310 may cause indications of the N applicants with the highest corresponding match strengths to be displayed based on their ordering, such as with the applicant with the highest match strength being displayed at the top of a GUI on the computing device, the applicant with the second highest match strength being displayed under the applicant with the highest match strength, and so on and so forth.

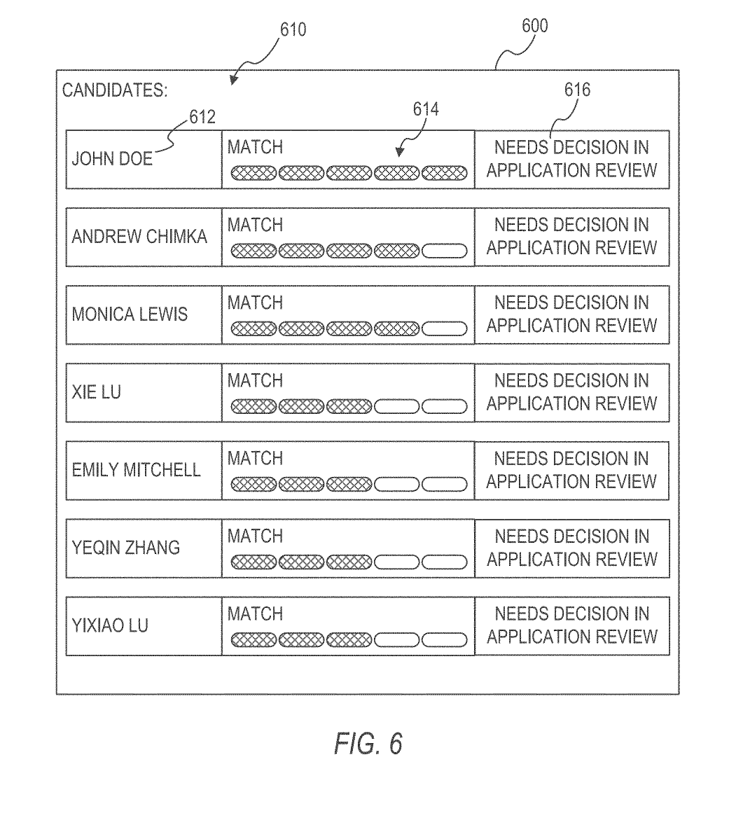

FIG. 6 illustrates a GUI 600 in which a list 610 of applicants for the job posting are displayed, in accordance with an example embodiment. The list 610 of applicants comprises a corresponding indication 612 (e.g., name) of each applicant, as well as an indication 614 of how strongly the application data of the corresponding applicant matches the criteria of the job posting (e.g., an indication of the match strength of the applicant). For example, GUI elements may be used to represent the match strength of each applicant's application data with respect to the criteria of the job posting. In FIG. 6, the match strength of an applicant is represented by filled-in bars, with the applicant having the highest generated match strength (e.g., “JOHN DOE” in FIG. 6) having the highest number of filled-in bars and being displayed at the top of the list 610 of applicants, and the applicant having the second highest generated match strength (e.g., “ANDREW CHIMKA” in FIG. 6) having the second highest number of filled-in bars and being the next displayed applicant under the applicant with the highest match strength, and so on and so forth, with the applicants being displayed in the order of their corresponding match strengths. The GUI 600 may also include an indication 616 that a decision needs to be made for the job application of the corresponding applicant (e.g., “NEEDS DECISION IN APPLICATION REVIEW”). This indication 616 may comprise a selectable link that, when selected by a user, presents the user with one or more selectable user interface elements that enable the user to tag the corresponding applicant of job application of the corresponding applicant with a decision, such as marking the corresponding applicant as being rejected, accepted, or requesting a follow-up procedure (e.g., the applicant has passed the initial review and should be interviewed).

In some example embodiments, the match module 310 is configured to receive a user input indicating a selection of an applicant displayed on the computing device. For example, the match module 310 may detect that the user viewing the list 610 of applicants displayed in the GUI 600 in FIG. 6 selects (e.g., clicks on, taps on, hovers over) the one of the applicant in the list 610, such as “JOHN DOE.” The user input may include, but is not limited to, the user clicking on the applicant, the user tapping on the applicant, and a hover event of a pointer over the applicant. In some example embodiments, the match module 310 is configured to, in response to or otherwise based on receiving the user input, cause at least a portion of the application data of the job application of the selected applicant to be displayed on the computing device, with the portion of the application data that is displayed being determined based on that portion of the application data satisfying the criteria of the job posting. In some example embodiments, the portion of the application data that is displayed in response to, or otherwise based on, the selection of the applicant comprises at least a portion of the resume data and at least a portion of the profile data.

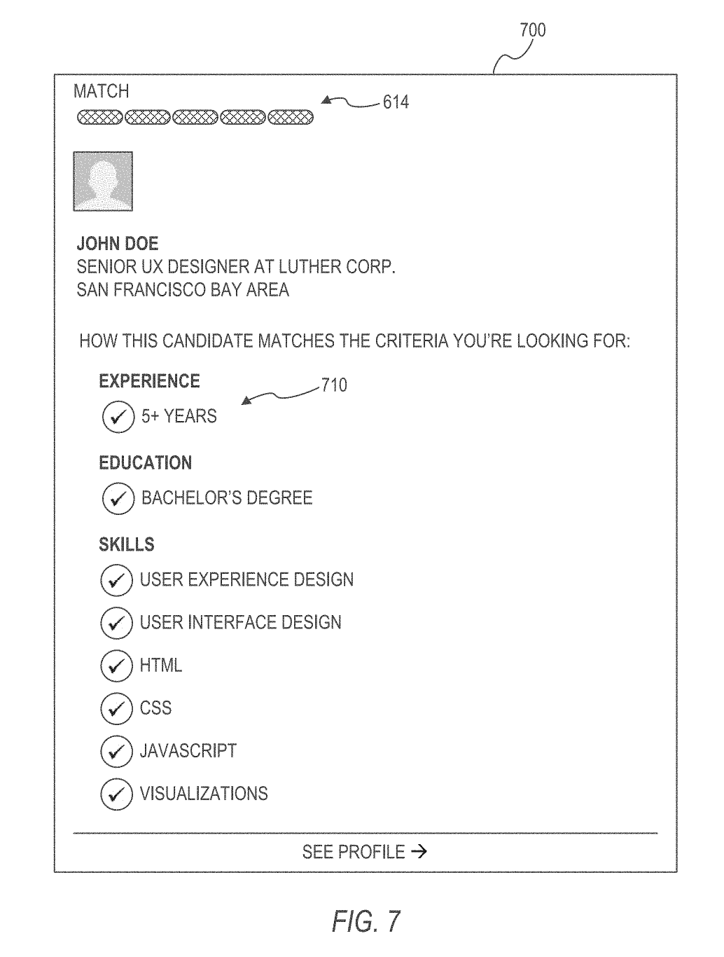

FIG. 7 illustrates a GUI 700 in which application data 710 of an applicant that satisfies criteria of a job posting is displayed, in accordance with an example embodiment. In some example embodiments, the match module 310 displays an indication that the displayed application data 710 satisfies criteria of the job posting. For example, a check mark or some other graphic indicator may be displayed next to each item of application data 710 that satisfies the criteria. Additionally or alternatively, in some example embodiments, the match module 310 is configured to display only the application data 710 that satisfies the criteria and omit any application data that does not satisfy the criteria from display in response to, or otherwise based on, the selection of the applicant. For example, in the example shown in FIG. 7, the GUI 700 only displays the application data 710 that satisfies the criteria, which is indicated by the check marks displayed next to each item of application data 710. By limiting the application data displayed to only the application data 710 that satisfies the criteria, the match module 310 provides a user interface experience that makes it clear to the user what criteria the selected applicant satisfies.

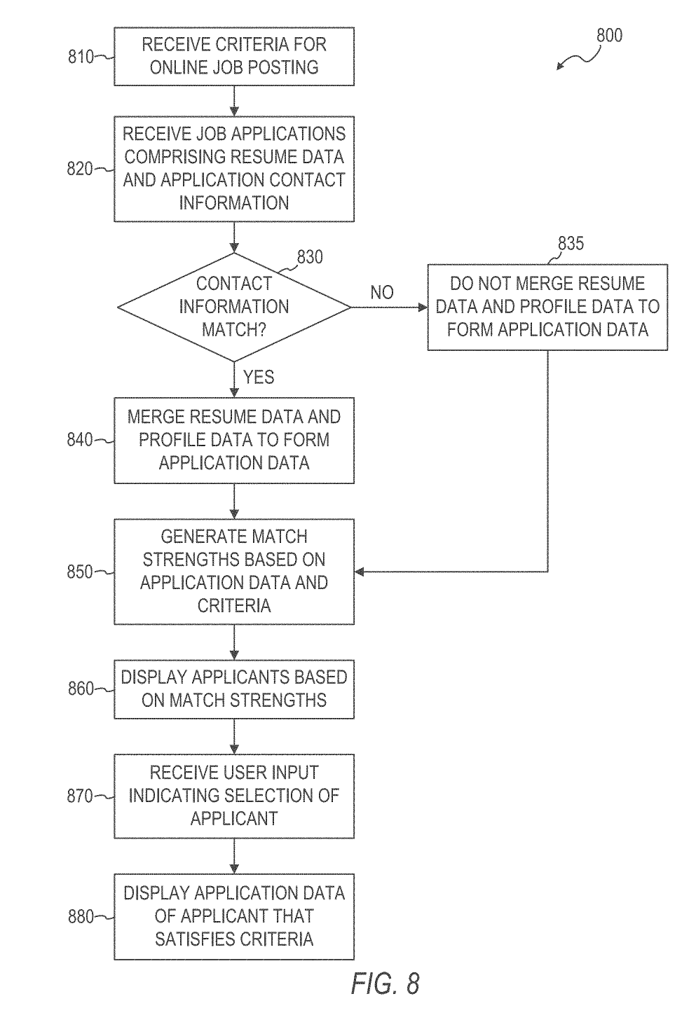

FIG. 8 is a flowchart illustrating a method 800 of merging data securely from different sources, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the merge and match system 216 of FIGS. 2-3, or any combination of one or more of its modules, as described above.

At operation 810, the merge and match system 216 receives at least one criteria for a job posting published on an online service. At operation 820, the merge and match system 216 receives a plurality of job applications for the job posting. In some example embodiments, each one of the job applications corresponds to a different applicant and comprises resume data and application contact information. In some example embodiments, the application contact information comprises at least one of an e-mail address or a destination for receiving text messages.

At operation 830, the merge and match system 216, for each one of the plurality of job applications, determines whether the application contact information of the job application matches profile contact information stored in association with a profile of the corresponding applicant of the job application on a social networking service. If the merge and match system 216 determines that the application contact information does not match the profile contact information, then, at operation 835, the merge and match system 216 does not merge the resume data of the job application with profile data of the profile of the corresponding applicant of the job application in forming application data of the job application.

If the merge and match system 216 determines that the application contact information matches the profile contact information, then, at operation 840, the merge and match system 216, merges the resume data of the job application with profile data of the profile of the corresponding applicant of the job application to form application data of the job application, the application data comprising the resume data and the profile data. In some example embodiments, the merging of the resume data with the profile data comprises retrieving the profile data from a database of the social networking service. In some example embodiments, the retrieving the profile data is performed in response to, or otherwise based on, the determination that the application contact information matches the profile contact information. In some example embodiments each one of the job applications further comprises an identification of the corresponding applicant, and the profile data of the profile of each one of the applicants is retrieved using the identification of the corresponding applicant.

At operation 850, the merge and match system 216, for each one of the applicants of the plurality of job applications, generates a corresponding match strength based on a comparison of the application data of the job application of the applicant with the at least one criteria. In some example embodiments, the corresponding match strength of each one of the job applicants is based on a measure of similarity between the application data of the job application of the applicant and the at least one criteria.

At operation 860, the merge and match system 216 causes at least a portion of the applicants of the plurality of job applications to be displayed on a computing device based on the generated match strengths of the job applications.

At operation 870, the merge and match system 216 receives a user input indicating a selection of an applicant of the at least a portion of the applicants. In some example embodiments, the user input comprises a hover event of a pointer over the applicant displayed on the computing device for a particular period of time (e.g., the pointer hovering over the applicant for 1 second). However, other types of user inputs are also within the scope of the present disclosure, including, but not limited to, a click event on the applicant and a tap event on the applicant.

At operation 880, the merge and match system 216, in response to receiving the user input, causes at least a portion of the application data of the job application of the applicant to be displayed on the computing device. The portion of the application data is determined based on the portion of the application data satisfying the criteria of the job posting. In some example embodiments, the portion of the application data comprises at least a portion of the resume data and at least a portion of the profile data.

It is contemplated that any of the other features described within the present disclosure can be incorporated into the method 800.

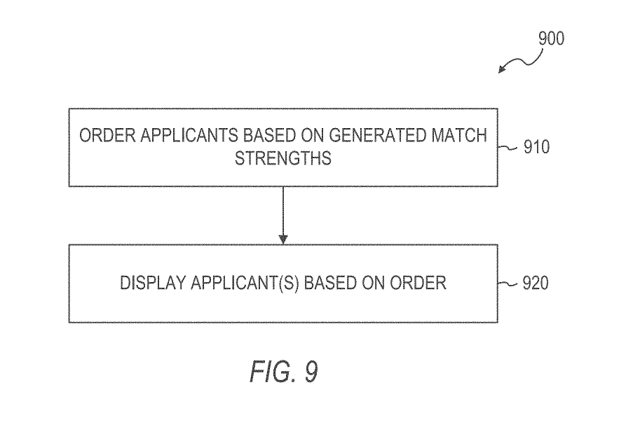

FIG. 9 is a flowchart illustrating a method 900 of causing applicants to be displayed, in accordance with an example embodiment. The method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the merge and match system 216 of FIGS. 2-3, or any combination of one or more of its modules, as described above.

At operation 910, the merge and match system 216 orders the applicants of the plurality of job applications based on the generated match strengths of the applicants. At operation 920, the merge and match system 216 causes at least portion of the applicants to be displayed on the computing device based on the order of the applicants.

It is contemplated that any of the other features described within the present disclosure can be incorporated into the method 900.

### Example Mobile Device

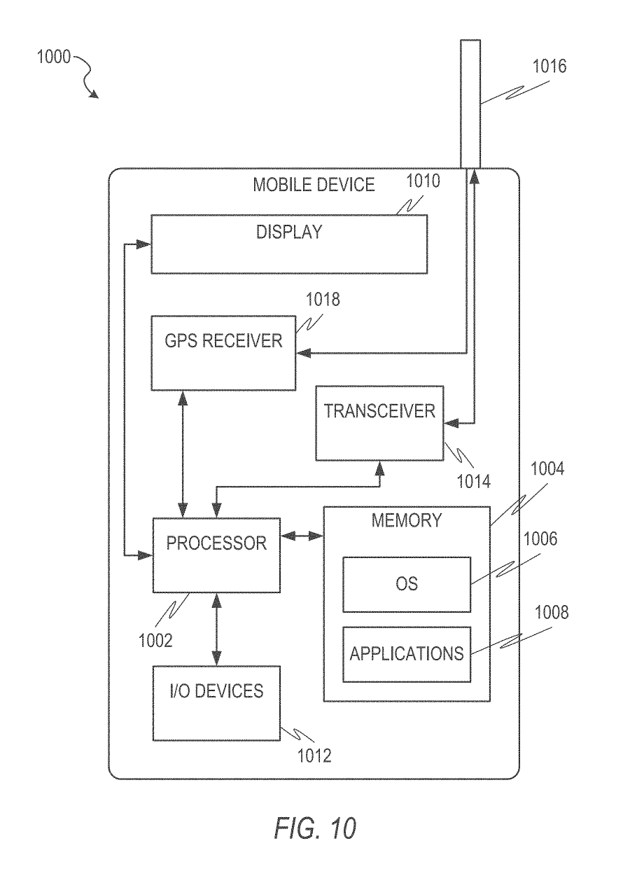

FIG. 10 is a block diagram illustrating a mobile device 1000, according to an example embodiment. The mobile device 1000 can include a processor 1002. The processor 1002 can be any of a variety of different types of commercially available processors suitable for mobile devices 1000 (for example, an XScale architecture microprocessor, a Microprocessor without Interlocked Pipeline Stages (MIPS) architecture processor, or another type of processor). A memory 1004, such as a random access memory (RAM), a Flash memory, or other type of memory, is typically accessible to the processor 1002. The memory 1004 can be adapted to store an operating system (OS) 1006, as well as application programs 1008, such as a mobile location-enabled application that can provide location-based services (LBSs) to a user. The processor 1002 can be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product. e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

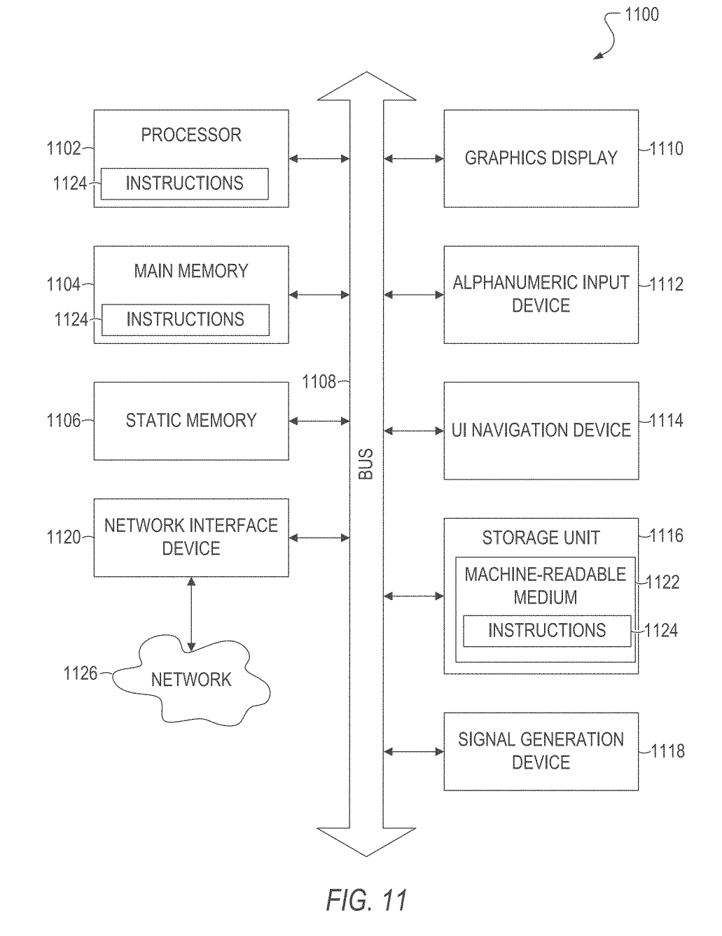

FIG. 11 is a block diagram of an example computer system 1100 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a graphics display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation device 1114 (e.g., a mouse), a storage unit 1116, a signal generation device 1118 (e.g., a speaker) and a network interface device 1120.

### Machine-Readable Medium

The storage unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions (e.g., instructions 1124) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, by a computer system having at least one hardware processor, at least one criteria for a job posting published on an online service;
receiving, by the computer system, a plurality of job applications for the job posting, each one of the job applications corresponding to a different applicant and comprising resume data and application contact information;
for each one of the plurality of job applications, determining, by the computer system, that the application contact information of the job application matches profile contact information stored in association with a profile of the corresponding applicant of the job application on a social networking service;
for each one of the plurality of job applications, merging, by the computer system, the resume data of the job application with profile data of the profile of the corresponding applicant of the job application to form application data of the job application, the application data comprising the resume data and the profile data, the merging of the resume data with the profile data comprises retrieving the profile data from a database of the social networking service and being performed based on the determining that the application contact information matches the profile contact information;
for each one of the applicants of the plurality of job applications, generating, by the computer system, a corresponding match strength based on a comparison of the application data of the job application of the applicant with the at least one criteria; and
causing, by the computer system, at least a portion of the applicants of the plurality of job applications to be displayed on a computing device based on the generated match strengths of the job applications.

2. The computer-implemented method of claim 1, wherein the contact information comprises at least one of an e-mail address or a destination for receiving text messages.

3. The computer-implemented method of claim 1, wherein the merging of the resume data with the profile data is performed in response to the determining that the application contact information matches the profile contact information.

4. The computer-implemented method of claim 1, wherein the retrieving the profile data is performed in response to the determining that the application contact information matches the profile contact information.

5. The computer-implemented method of claim 1, wherein each one of the job applications further comprises an identification of the corresponding applicant, and the profile data of the profile of each one of the applicants is retrieved using the identification of the corresponding applicant.

6. The computer-implemented method of claim 1, wherein the causing the at least a portion of the applicants to be displayed on the computing device comprises:
ordering the applicants of the plurality of job applications based on the generated match strengths of the applicants; and
causing the at least a portion of the applicants to be displayed on the computing device based on the ordering of the applicants.

7. The computer-implemented method of claim 1, wherein the corresponding match strength of each one of the job applicants is based on a measure of similarity between the application data of the job application of the applicant and the at least one criteria.

8. The computer-implemented method of claim 1, further comprising:
receiving a user input indicating a selection of an applicant of the at least a portion of the applicants; and
in response to receiving the user input, causing at least a portion of the application data of the job application of the applicant to be displayed on the computing device, the at least a portion of the application data being determined based on the at least a portion of the application data satisfying the at least one criteria.

9. The computer-implemented method of claim 8, the at least a portion of the application data comprising at least a portion of the resume data and at least a portion of the profile data.

10. The computer-implemented method of claim 8, wherein the user input comprises a hover event of a pointer over the applicant displayed on the computing device.

11. A system comprising:
at least one hardware processor; and
a non-transitory machine-readable medium embodying a set of instructions that, when executed by the at least one hardware processor, cause the at least one processor to perform operations, the operations comprising:
receiving at least one criteria for a job posting published on an online service;
receiving a plurality of job applications for the job posting, each one of the job applications corresponding to a different applicant and comprising resume data and application contact information;
for each one of the plurality of job applications, determining that the application contact information of the job application matches profile contact information stored in association with a profile of the corresponding applicant of the job application on a social networking service;
for each one of the plurality of job applications, merging the resume data of the job application with the profile data of the profile of the corresponding applicant of the job application to form application data of the job application, the application data comprising the resume data and the profile data, the merging of the resume data with the profile data being performed based on the determining that the application contact information matches the profile contact information;
for each one of the applicants of the plurality of job applications, generating a corresponding match strength based on a comparison of the application data of the job application of the applicant with the at least one criteria; and
causing at least a portion of the applicants of the plurality of job applications to be displayed on a computing device based on the generated match strengths of the job applications.

12. The system of claim 11, wherein the contact information comprises at least one of an e-mail address or a destination for receiving text messages.

13. The system of claim 11, wherein the merging of the resume data with the profile data is performed in response to the determining that the application contact information matches the profile contact information.

14. The system of claim 11, wherein the merging comprises retrieving the profile data of the profile of the corresponding applicant from a database of the social networking service.

15. The system of claim 14, wherein the retrieving the profile data is performed in response to the determining that the application contact information matches the profile contact information.

16. The system of claim 14, wherein each one of the job applications further comprises an identification of the corresponding applicant, and the profile data of the profile of each one of the applicants is retrieved using the identification of the corresponding applicant.

17. The system of claim 11, wherein the causing the at least a portion of the applicants to be displayed on the computing device comprises:
ordering the applicants of the plurality of job applications based on the generated match strengths of the applicants; and
causing the at least a portion of the applicants to be displayed on the computing device based on the ordering of the applicants.

18. The system of claim 11, wherein the operations further comprise:
receiving a user input indicating a selection of an applicant of the at least a portion of the applicants; and
in response to receiving the user input, causing at least a portion of the application data of the job application of the applicant to be displayed on the computing device, the at least a portion of the application data being determined based on the at least a portion of the application data satisfying the at least one criteria.

19. The system of claim 18, the at least a portion of the application data comprising at least a portion of the resume data and at least a portion of the profile data.

20. A non-transitory machine-readable medium embodying a set of instructions that, when executed by at least one hardware processor, cause the processor to perform operations, the operations comprising:
receiving at least one criteria for a job posting published on an online service;
receiving a plurality of job applications for the job posting, each one of the job applications corresponding to a different applicant and comprising resume data and application contact information;
for each one of the plurality of job applications, determining that the application contact information of the job application matches profile contact information stored in association with a profile of the corresponding applicant of the job application on a social networking service;
for each one of the plurality of job applications, merging the resume data of the job application with the profile data of the profile of the corresponding applicant of the job application to form application data of the job application, the application data comprising the resume data and the profile data, the merging of the resume data with the profile data being performed based on the determining that the application contact information matches the profile contact information;
for each one of the applicants of the plurality of job applications, generating a corresponding match strength based on a comparison of the application data of the job application of the applicant with the at least one criteria; and
causing at least a portion of the applicants of the plurality of job applications to be displayed on a computing device based on the generated match strengths of the job applications.
